(19) United States
(12) Patent Application Publication
(10) Pub. No.: US 2008/0097994 A1
(43) Pub. Date: Apr. 24, 2008

(54) Method of extracting community and system for the same

(75) Inventors: Yaemi Teramoto, Tokyo (JP); Yasutsugu Morimoto, Kodaira (JP); Tatsuhiko Miyata, Kokubunji (JP)

Correspondence Address: Stanley P. Fisher;Reed Smith Hazel & Thomas LLP, Suite 1400, 3110 Fairview Park Drive, Falls Church, VA, 22042-4503, US

(73) Assignee: Hitachi, Ltd.

(21) Appl. No.: 11/976,300

(22) Filed: Oct. 23, 2007

(30) Foreign Application Priority Data
Oct. 23, 2006 (JP) 2006-287116

(51) Int. Cl. G06F 17/30

(52) U.S. Cl. 707/7; 707/E17.002

(57) ABSTRACT

A community is extracted by executing steps of: clustering relationship data; extracting a communication core of a relationship network; mapping the communication core to a dendrogram of relationship data; forming a community by using the dendrogram in accordance with a similarity degree of relationship data while the cluster is expanded; and aggregating communities. A community of a set of persons having high density relationships based on common topics and interests can be extracted from a set of human relationships and relationship data representative of the human relationships.

### CLAIM OF PRIORITY

The present application claims priority from Japanese application JP 2006-287116 filed on Oct. 23, 2006, the content of which is hereby incorporated by reference into this application.

### BACKGROUND OF THE INVENTION

1. Field of the Invention

The present invention relates to technologies of extracting a community as an aggregation of persons having high density relationships based on common topics and interests, from an aggregation of human relationships and relationship data representative of the human relationships.

2. Description of the Related Art

Human relationships can be accumulated nowadays as electronic data from communication tools such as mails, blogs, bulletin boards, chats and social network services (SNS) and information on links and browser records on the Web. Under this circumstance, technologies have been paid attention to providing new values based on the features of a network, by analyzing human relationships extracted from electronic data, as a social network. For example, a technique has been developed for finding a community as an aggregation of persons, selecting a community matching a person, and providing information matching the features of a community.

In the invention described in JP-A-2004-127196, a characteristic word list at each terminal is formed in accordance with information transmitted/received at each terminal, and terminals are grouped in accordance with a similarity degree of respective word lists. However, a relationship between terminals is not considered.

In the invention described in JP-A-2005-244647, a network is obtained interconnecting users performing electronic mail transfer at a high occurrence frequency, and this network is output as a latent community. However, text contents of mails are not considered.

According to a communication core extracting method described in “SR: Method of Extracting Tightly Coupled Communication Cores in Network, October 2005” by Kazumi SAITO, et al., a portion of denser links is extracted as a communication core from a human relationship network by utilizing name co-occurrence on the Web. However, the contents and features of human relationships are not considered.

### SUMMARY OF THE INVENTION

The conventional community extracting method includes a method of paying attention to a density of human relationships and a method of using persons having similar profiles as an aggregation. However, in a real human society, each person has a plurality of roles and participates in a plurality of communities in accordance with the roles. The same relationship between two persons is considered to have a plurality of types depending upon a role of each person. With the conventional method, it is difficult to express the features of human relationships in a real society.

An object of the present invention is to provide a community extracting method suitable for a real human society by incorporating the technology of extracting a community which is an aggregation of persons having high density relationships based on common topics and interests, from an aggregation of human relationships and communication data representative of the human relationships.

Another object of the present invention is to provide a method of feeding back a communication record automatically reflecting information obtained from a function obtained by applying the community extracting method, upon human relationships.

In order to achieve the above objects, the community extracting method of the present invention extracts a community through the collaboration between clustering based on relationship data and extracting a communication core having high density human relationships. More specifically, the communication core is mapped to a cluster of a dendrogram (tree diagram), and starting from this cluster, the cluster is expanded in accordance with a similarity degree of relationship data, by using the dendrogram, to form a community. The community forming process is terminated in accordance with threshold values of a community density, a size of a cluster to be processed, and the number of process repetitions, and thereafter the community is output.

A typical system adopting the present invention is constituted of an information processing apparatus including at least data storing means for storing data and data processing means for processing the data stored in the data storing means. This system applied to a network includes a plurality of information terminals, a communication system for controlling communications among these information terminals, and a search system for processing information transmitted/received at the information terminals. A user accessing the information terminal is identified by an ID for example.

The scope of the present invention includes a search system performing a novel community extracting process. In a specific example, the search system is constituted of a server connected to a network and a program running on the server. The search system monitors or collects data flowing on the network, and clusters the data in accordance with a similarity degree to form a dendrogram (will be detailed later with reference to FIG. 6). In another embodiment, data processing is performed in accordance with data accumulated in advance, to extract a community. In this case, the system may be a stand-alone type. Human relationship data is configured by correlating a plurality of users relevant to particular data. Correlation means, for example, transmission/reception, formation, reference, correction and the like (will be described later with reference to FIGS. 8 and 24, and the like).

According to the present invention, a community pertaining to a particular theme can be extracted by comparing a dendrogram indicating the correlation (similarity or the like) between data and a human relationship network. An example of a basic operation of the search system of the present invention will be described hereunder.

According to the present invention, a human relationship network indicating the correlation between users is generated to hold the network as data. Although the details will be described later, the human relationship is such as shown at 72 in FIG. 7, and indicates the correlation among users A, B, C and etc. For example, the correlation can be expressed by a relevance degree to the same data, a relevance frequency, a frequency and the number of contacts such as mails, and the like.

A dendrogram is formed which is obtained through clustering based on a similarity degree of relationship data relevant to users, and the dendrogram is stored as data. Although the details will be described later, the dendrogram is such as indicated at 71 in FIG. 7. In this example, data 1, 2, 3 and etc. is mapped in a tree shape in accordance with a similarity degree, and users A, B, C and etc. are shown correlated to the data.

Next, one or a plurality of communication cores containing a plurality of users as constituent members are extracted from the human relationship network. For example, the users A, B and C are extracted from the human relationship network 72 as a communication core having high relevancy. An extracting method may be a well-known method. For example, high density portions can be extracted based on the graph theory.

Next, the communication core is mapped to the dendrogram to form a community including at least constituent members of the communication core. Mapping may use a multiplicity between the constituent members of the communication core and the constituent members of the cluster of the dendrogram. More specifically, by paying attention to the cluster of the dendrogram to which the communication core was mapped, the cluster is extracted which includes at least a portion of the constituent members of the communication core as the users relevant to the data.

For example, clusters are sequentially searched from the lower end portion (a lower portion in FIG. 7) of the dendrogram, and the cluster including the constituent members is extracted as a community. In the example shown in FIG. 7, a subtree T₀ can be extracted as the community including users A, B and C as the constituent members. It is to be noted that a user D having a relationship with the constituent member C of the communication core via data 2 is contained in the community.

In the manner described above, a community can be extracted by using information on both the human relationships and a relevance degree (or presence/absence) to similar data.

According to a preferred embodiment of the present invention, a community can be expanded by comparing the dendrogram representative of relationships of relationship data with the human relationship network.

A specific example will be described referring again to FIG. 7. The subtree T₀ of the dendrogram is considered as the cluster having the highest member multiplicity, because the cluster contains all the users A, B and C as the constituent members of the communication core of the human relationship network. Therefore, this subtree is used as a base cluster, and users A, B and C are members of a base community. Next, T₀ is expanded to T₁, which is the parent subtree of T₀. In this subtree T₁, users A, B, C, and D exchanged relationship data 1, 2 and 3 in the cluster are used as addition candidates to the base community. If the addition candidate users and any member of the base community have a human relationship (e.g., access, communication of the same data), the addition candidate users are added as the members of the base community. In the example shown in FIG. 7, the user D is added to the community since it can be known that there is a human relationship between the member A of the base community and the candidate D, by referring to the human relationship network 72.

By sequentially repeating similar processes, the community can be expanded. As the expansion procedure, for example, the dendrogram is traced along the aggregation direction (route direction, an up direction in FIG. 7) of the dendrogram, to search a cluster of the dendrogram having a next higher similarity degree and repeat similar processes. As the processes are repeated, the community expands. However, if the processes are repeated infinitely, this is not realistic if the amount of data is large. It is therefore practical to set a threshold value of the number of repetitions.

For example, the following termination approaches may be used.

(1) A relationship density in a community is used as a threshold value, and if the density becomes not larger than a predetermined value, the process is terminated.

(2) A size of a cluster of the dendrogram to be added next to the community is used as a threshold value, and if the size becomes not smaller than a predetermined value, the process is terminated.

(3) The number of repetitions of a process of tracing the dendrogram toward the aggregation direction and adding a member to the community is used as a threshold value, to terminate the process.

According to the present invention, it is possible to effectively extract users pertaining to a particular theme as a community.

### BRIEF DESCRIPTION OF THE DRAWINGS

FIG. 1 is a flow chart illustrating a community extracting method.

FIG. 2 is a flow chart illustrating the details of a relationship data clustering step.

FIG. 3 is a flow chart illustrating the details of a step of mapping a communication core to a dendrogram.

FIG. 4 is a flow chart illustrating the details of a community forming step.

FIG. 5 is a diagram showing an example of a distance matrix.

FIG. 6 is a diagram showing an example of a cluster dendrogram of relationship data.

FIG. 7 is a diagram showing a cluster dendrogram of relationship data and a corresponding human relation network.

FIG. 8 is a diagram illustrating a community forming process.

FIG. 9 is a diagram showing the outline of a network of a Know-Who search system, a communication system and information terminals.

FIG. 10 is a physical configuration diagram.

FIG. 11 is a module configuration diagram of an information terminal.

FIG. 12 is a module configuration diagram of a Know-Who search server.

FIG. 13 is a module configuration diagram of a presence server.

FIG. 14 is a module configuration diagram of a SIP server.

FIG. 15 is a sequence diagram illustrating the operation of a Know-Who search system according to a first embodiment.

FIG. 16 is a diagram showing a Know-Who search application operation screen.

FIG. 17 is a diagram showing a SIP server log table.

FIG. 18 is a diagram showing a presence server log table.

FIG. 19 is a diagram showing a Know-Who search server operation record table.

FIG. 20 is a diagram showing a cluster dendrogram table.

FIG. 21 is a diagram showing a community table.

FIG. 22 is a diagram showing a relationship network matrix of the first embodiment.

FIG. 23 is a diagram showing a communication core table.

FIG. 24 is a diagram showing a relationship data table.

FIG. 25 is a flow chart illustrating community search.

FIG. 26 is a flow chart illustrating intermediate path search.

FIG. 27 is a diagram showing a relationship network matrix of the second embodiment.

FIG. 28 is a sequence diagram illustrating the operation of a Know-Who search system according to a second embodiment.

FIG. 29 is a diagram showing an intermediate path table.

### DESCRIPTION OF THE EMBODIMENTS

One of efficient applications of a community extracting method of the present invention is a Know-Who search system.

### First Embodiment

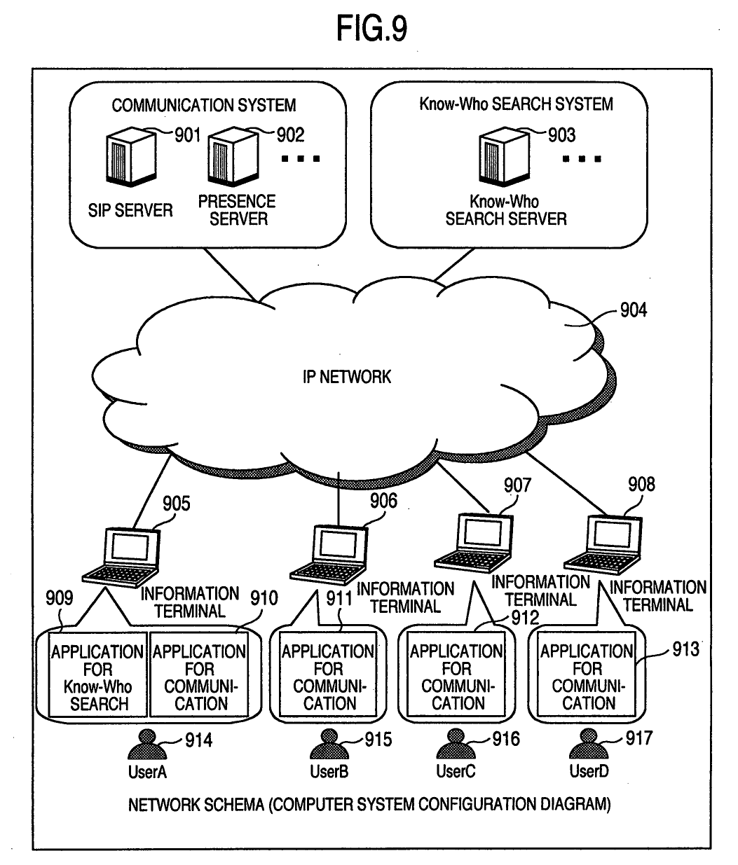

FIG. 9 is a diagram showing the outline of a network according to the first embodiment. Information terminals 905 906, 907 and 908 are connected to a session initiation protocol (SIP) server 901, a presence server 902 and a Know-Who search server 903 via an IP network 904. SIP is a protocol for controlling a state from a partner user call to an end of communications with the partner user, for a variety of communications among users with text, audio/video data and the like. SIP is a protocol standardized by Internet Engineering Task Force (IETF). In this example, although control is made by SIP, the control protocol may be a protocol different from SIP. As a user A 914 transmits a request for a Know-Who search for searching an expert on information desired by the user, by using a Know-Who search application 909 equipped in the information terminal 905, the Know-Who search server 903 receives the request via the IP network, executes a search and transmits the search result, and the information terminal 905 receives and displays the search result. The user A selects a communication partner (in this example, it is assumed that one of users B, C and D is selected) from the search result, and performs inter-terminal communications with the selected user via the IP network 904, SIP server 901 and presence server 902 by using the communication applications 910 and 911, 912 or 913 of the information terminals 905 and 906, 907 or 908.

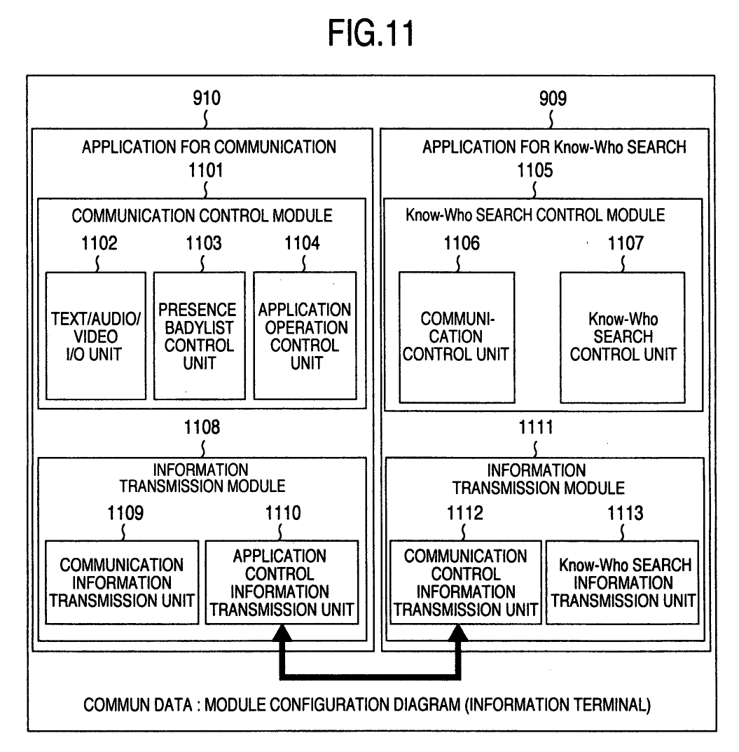

FIGS. 11 to 14 are functional block diagrams of the information terminal 905, Know-Who search server 903, presence server 902 and SIP server 901. Although the functional block diagrams shown in FIGS. 11 to 14 show logical function structures realized by software, each functional block may be configured by hardware.

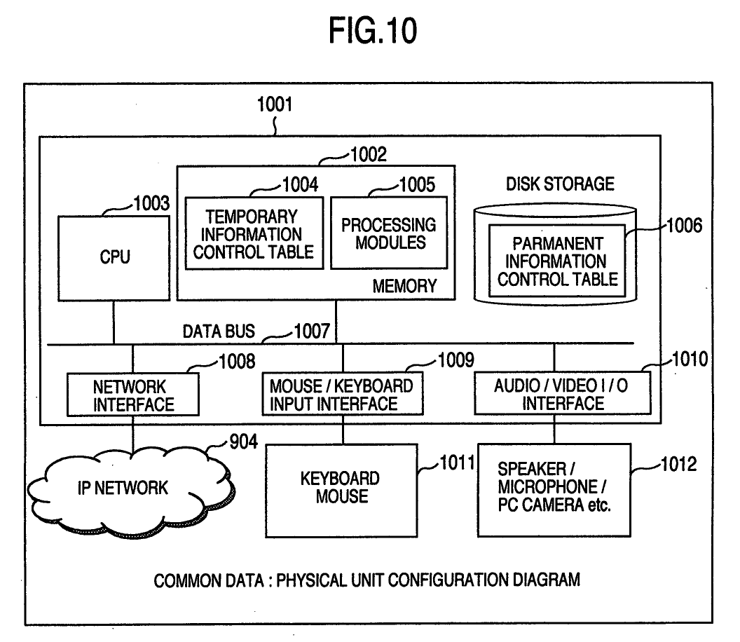

FIG. 10 shows how each functional block shown in FIGS. 11 to 14 is realized by hardware. For example, FIG. 10 shows the structure of a server or a computer to be connected to the IP network 904. This apparatus includes a main body 1001 and I/O units 1011 and 1012. In accordance with a program running a CPU 1003, this apparatus can bear a role of one or a plurality of the information terminal 905, Know-Who search server 903, presence server 902 and SIP server 901. Namely, the operation sequence of each of the functional blocks shown in FIGS. 11 to 14 is stored in processing modules 1005 of a memory 1002 shown in FIG. 10, and during operation, CPU 1003 reads and executes the operation sequence. Information necessary for each processing module to operate is stored in a permanent information control table 1006 stored in a disk storage such as a hard disk and in a temporary information control table 1004 on the memory 1002, and information is read and written when necessary. When the information terminals 905 to 908 perform actual text communications, a mouse/keyboard 1011 is connected to a mouse/keyboard I/O interface 1009, and when the information terminals perform audio-video communications, a device 1012 such as a speaker, a microphone and a PC camera is connected to an audio/video I/O interface 1010. Actual data is transferred to CPU 1003 via a data bus 1007 and processed at CPU. This apparatus is connected to the IP Network 904 via a network interface 1008.

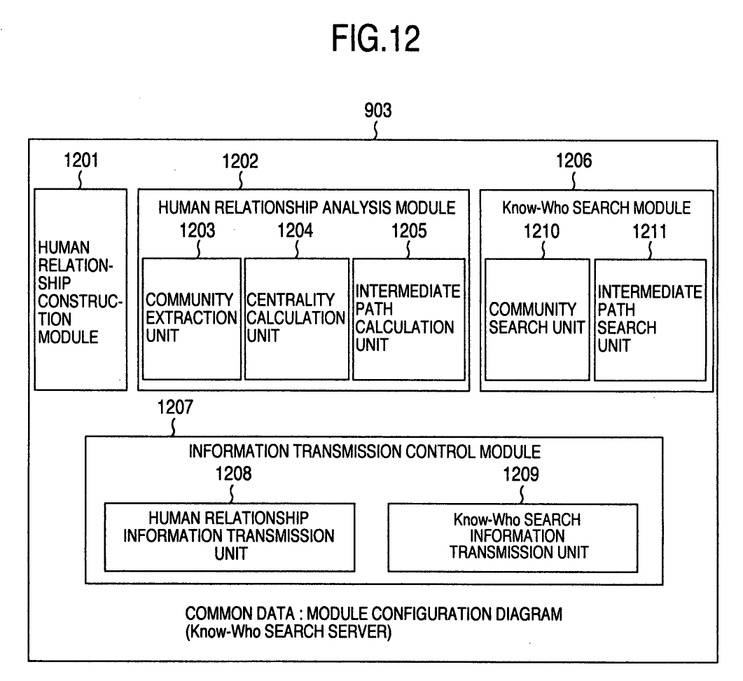

Description will now be made on each functional block shown in FIGS. 11 to 14. First, the most important function of the Know-Who search server 903 shown in FIG. 12 will be described.

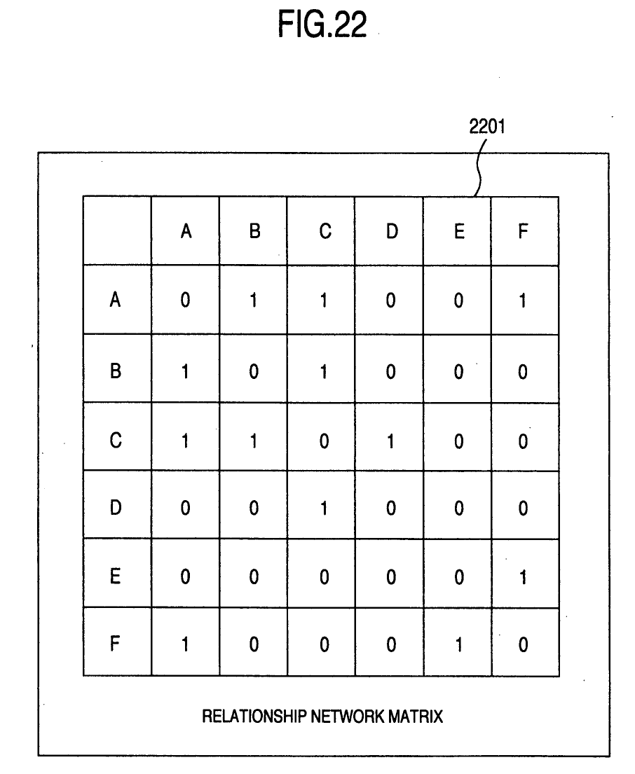

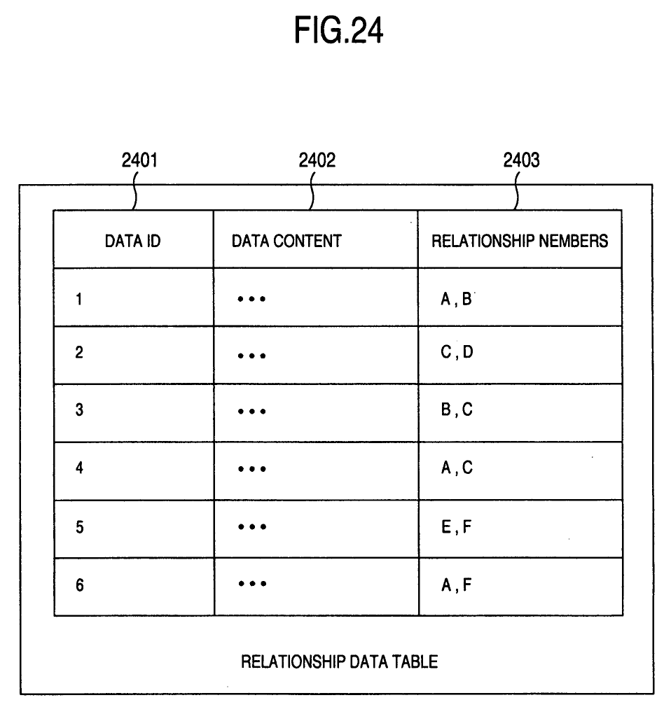

The Know-Who search server 903 shown in FIG. 12 has mainly two roles. The first role is to configure human relationship data. A human relationship information transmission/reception unit 1208 receives human relationship information, and a human relationship construction module 1201 configures and updates the human relationship data. The human relationship information to be received may have various forms including: data used for communications such as mails; text data jointly formed by a plurality of persons; video data transmitted/received between persons; and the like, and is defined as data pertained by a plurality of persons. First, the human relationship construction module changes the received human relationship information to a relationship data table. An example of the relationship data table is shown in FIG. 24. This table contains a data ID 2401, a content 2402 and relationship members 2403 relevant to each data. As described earlier, the content may have various forms such as text and audio/video. In the example shown in FIG. 24, the content is not specifically defined. Next, a relationship network having a person as a node and a relationship as an edge is formed from the relationship data table, as a matrix having the number of relationship data between persons as an element value. An example of the relationship network matrix is shown in FIG. 22. It can be considered that element values of the relationship network matrix are directly rewritten by using information received at the human relationship information transmission/reception unit. This approach will be described in the second embodiment. The second role is to execute a Know-Who search. A Know-Who search information transmission/reception unit 1209 of an information transmission/reception control module 1207 receives a search query and a search request, a Know-Who search module 1206 executes a search by using units 1203, 1204 and 1205 of a human relationship analysis module 1202, and the Know-Who search information transmission/reception unit 1209 transmits the search result. The search to be executed by the Know-Who search module 1206 includes two searches: a community search to be executed by a community search unit 1210 and an intermediate path search to be executed by an intermediate path search unit 1211. The details of these searches will be described hereunder.

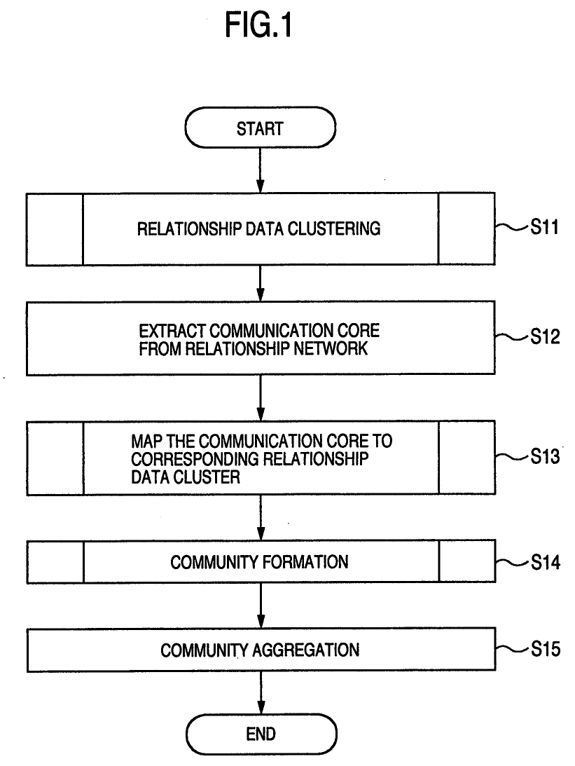

With reference to flow charts shown in FIGS. 1 to 4 and FIG. 25, the process to be executed by the Know-Who search module 1206 will be described.

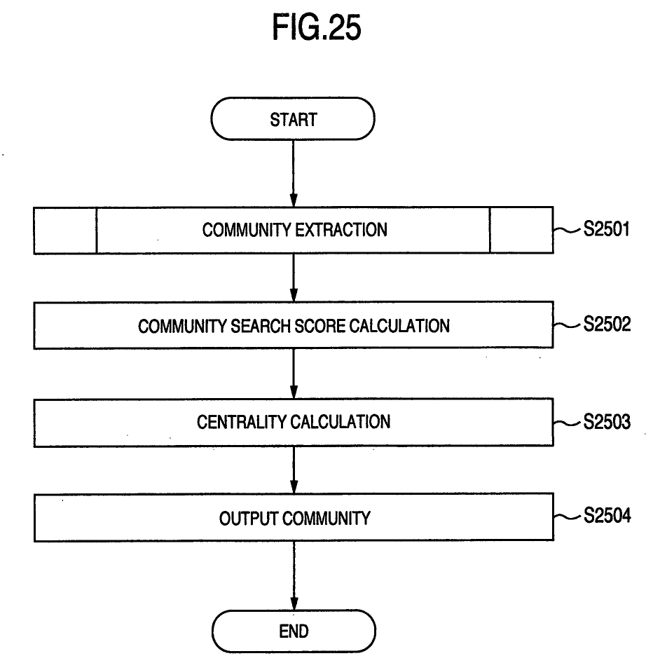

FIG. 25 is the flow chart illustrating the overall sequence of the process to be executed by the community search unit 1210. In the Know-Who search module, if the received search request is a community search for searching an expert in a particular knowledge field, the community search unit executes a process. The particular knowledge field as the search query is given by a keyword or the like.

At a community extraction step S2501, the relationship data table (FIG. 24) and the relationship network matrix (FIG. 22) are input, and a community table is output. An example of the community table is shown in FIG. 21. This table has a community ID 2101, community members 2102 belonging to the community, relationship data of the community 2103, and a score 2105 given at a step S2502. The process at S2501 is executed by the community extraction unit 1203. The details of this process will be described later.

At a community search score calculation step S2502 the community table output at S2501 is input, and a matching score is calculated for the received search query. An example of a method of calculating a matching score if the relationship data is text data is a method by which text data of merged community data (human relationship data of the community, the details of which will be later described) is formed for each community, the text data is scored relative to the search query by using a full text search engine (Revised “Configuration and Utilization of Namazu System” by Hajime BABA, Soft Bank Creative, published on Jul. 1, 2003) or the like, and this score is used as a matching score of the community relative to the search query. By calculating the community search score, it becomes possible to display communities by rearranging the communities in the order in conformity with the search query.

At a centrality calculation step S2503 a centrality is calculated for each community member of each community in the input community table output at S2501. The process at S2503 is executed by the centrality calculation unit 1204. A centrality is an index indicating a centrality degree of each node in the network (“Fundamentals of Social Network Analysis (Chapter 6 Centrality)” by Jun KANEMITU, published on Dec. 20, 2003). By calculating centralities, it is possible to rearrange and display community members in the order of higher centrality degree.

A community output step S2504 outputs a set of communities extracted at S2501, and scores and centrality values calculated at S2502 and S2503. A user transmitted the community search query can select efficiently an expert in a particular knowledge field, by using output information on the community and community members.

FIGS. 1 to 4 are the flow charts illustrating the process to be executed by the community extraction unit 1203. Description will be made on the operation of the community extraction process, by inputting exemplary data shown in FIGS. 21 and 24. In the exemplary data, six persons A, B, C, D, E and F have relationships in accordance with six pieces of data 1 to data 6.

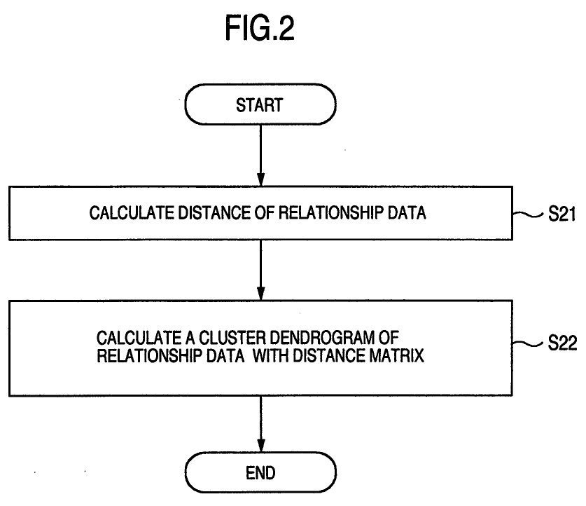

FIG. 1 is the flow chart illustrating the overall sequence of the community extracting process. At a relationship data clustering step S11, a data set such as text/audio/video representative of relationship data is input, a dendrogram is output which settled data in the order of closeness (higher similarity). This dendrogram is called a cluster dendrogram of relationship data. By using the cluster dendrogram, clusters having a variety of sizes can be formed, the cluster being an aggregation of relationship data based on the data similarity. A cluster of the relationship data is an arbitrary subtree of the cluster dendrogram of relationship data. Examples of the relationships and relationship data are provided in the following. In mail communications, relative to the relationship between mail sender and receiver, a mail title/main text and an appended file such as images are the relationship data. In the case of Web page browsing, relative to the relationship between a Web page creator and an access person, contents of the Web page are the relationship data. In the case of paper joint authorship, relative to the relationship between a main author and a coauthor or between coauthors, the paper contents are the relationship data. The details of this process will be later described with reference to the flow chart of FIG. 2.

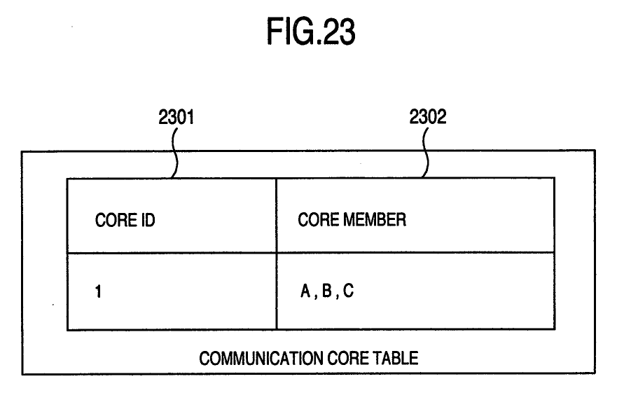

At a step S12 of extracting communication cores from the relationship network, the relationship network matrix is input, and a communication core having a high relationship density is extracted from the relationship network matrix and output. The core extracting method may be N-Clique, K-Plex in the graph theory(“Social Network Analysis” by John Scott, A handbook Second Edition, Chapters 6 & 7, pp. 100 to 145, SAGE Publications Ltd., 2000), an SR method (“A method of Extracting Core of Tight Coupling from Network” by Kazumi SAITO, et al.) or the like. A set of cores is used as a seed for forming a community. For example, the relationship network matrix shown in FIG. 22 is input, and as 1-Clique which is a subgraph of nodes directly connected with all other nodes is extracted as the communication core, the extracted communication core has three persons (A, B, C). The communication core is managed by a communication core table shown in FIG. 23. The table has a core ID 2301 and a core member 2302 constituting the core.

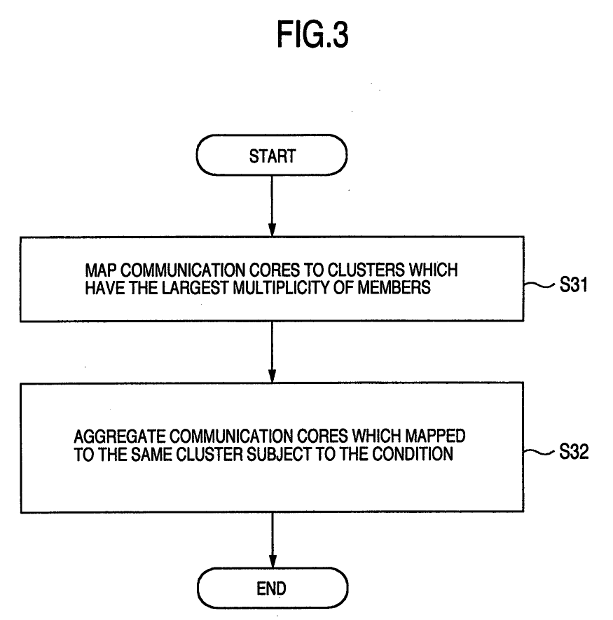

At a step S13 of mapping the communication core to the dendrogram of human relationship data, the dendrogram output at S11 and the communication core output at S12 are input, and a pair of the communication core and the dendrogram subtree is output. This pair of the communication core and the cluster is a starting point of forming a community. The details of this process will be later described with reference to the flow chart of FIG. 3.

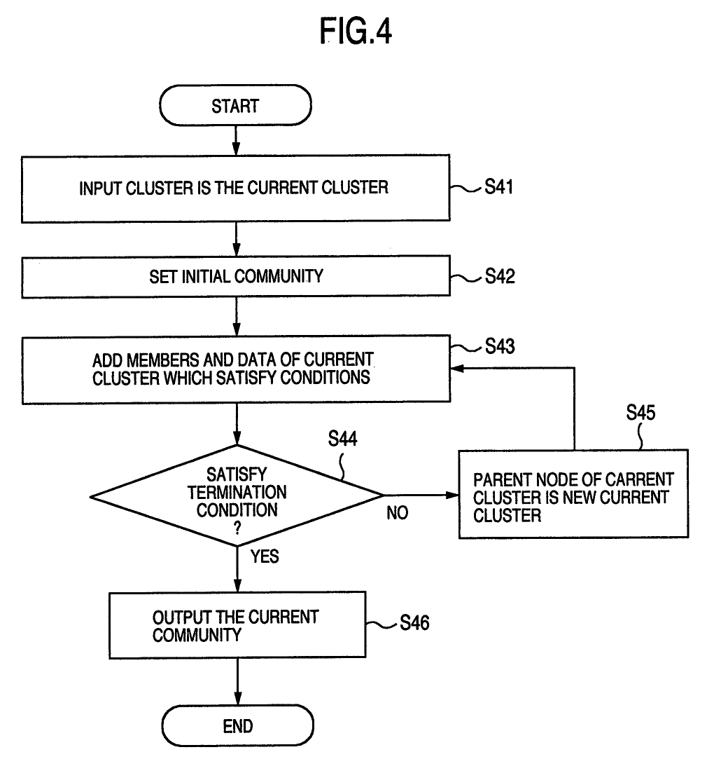

At a step S14 of forming a community, pairs of the communication core and the dendrogram subtree output at S13 are input, and communities are output, which are formed by expanding the clusters of relationship data of the dendrogram from each starting point of the pairs. With this step, a community having common relationships and high relationship density can be formed. The details of this process will be later described with reference to the flow chart of FIG. 4.

At a community aggregation step S15, all communities formed at S14 are input, and a plurality of communities having a large duplication are aggregated into one community, and a set of aggregated communities is output. The community aggregation condition may be defined that a community member duplication (formula 1) and a community data duplication (formula 2) are not smaller than threshold values. With this step, communities having different starting points and expanded to the same community during the community formation are aggregated to one community.

$$Community member duplication = \frac{{n}_{m 1 ⋂ 2}}{( {n}_{m 1} + {n}_{m 2} ) / 2} \qquad ( 1 )$$

where nₘ₁ is the number of members of a community 1, nₘ₂ is the number of members of a community 2, and n_{m1∩2} is the number of duplicated members of the communities 1 and 2.

$$Community data duplication = \frac{{n}_{d 1 ⋂ 2}}{( {n}_{d 1} + {n}_{d 2} ) / 2} \qquad ( 2 )$$

where n_{d1} is the number of data pieces of the community 1, n_{d1∩2} is the number of data pieces of the community 2, and n_{d1∩2} is the number of duplicated data pieces of the communities 1 and 2.

FIG. 2 is the flow chart illustrating the relationship data clustering step S11. At a step S21 of calculating a distance between relationship data, a relationship data set is input, and a distance matrix having distances between relationship data as matrix elements is output. This distance matrix is used for calculating the cluster dendrogram. A distance matrix calculating method will be described specifically on the assumption that the relationship data is text data such as mails. Words are derived from each relationship text data by using morphological analysis techniques or the like, and a list of words and their occurrence frequency for each data is formed. By using the formed word list, relative to each data piece, all the data pieces are scored in accordance with a similarity degree. As a score calculating method, methods such as SMART (“New retrieval approaches using SMART” by Buckley, et al, TREC4, pp. 25 to 48, 1966) are known. With SMART, data having a high similarity to comparison reference data has a high score. The method of scoring text data is well-known techniques in the field of similar document search. Calculated scores are normalized so that the score of the comparison reference data becomes “1”. A distance to the comparison reference data is represented by a value obtained by subtracting the normalized score of each data from the maximum value “1”. A distance between data 1 and data 2 is represented by an average of a distance of data 2 using data 1 as a reference and a distance of data 1 using data 2 as a reference. In the example, the distance matrix of data 1 to data 6 is shown in FIG. 5. The distance matrix of FIG. 5 is shown as a triangle matrix because an element (i, j) and an element (j, i) take the same value where the element (i, j) represents a distance between data i and data j. An element (i, i) takes a value “0” because it represents a distance between the same text. The distance between relationship data may be defined using similarity of data, similarity or coincidence of data genre, coincidence of data format, coincidence of data itself and the like, in addition to similarity of text.

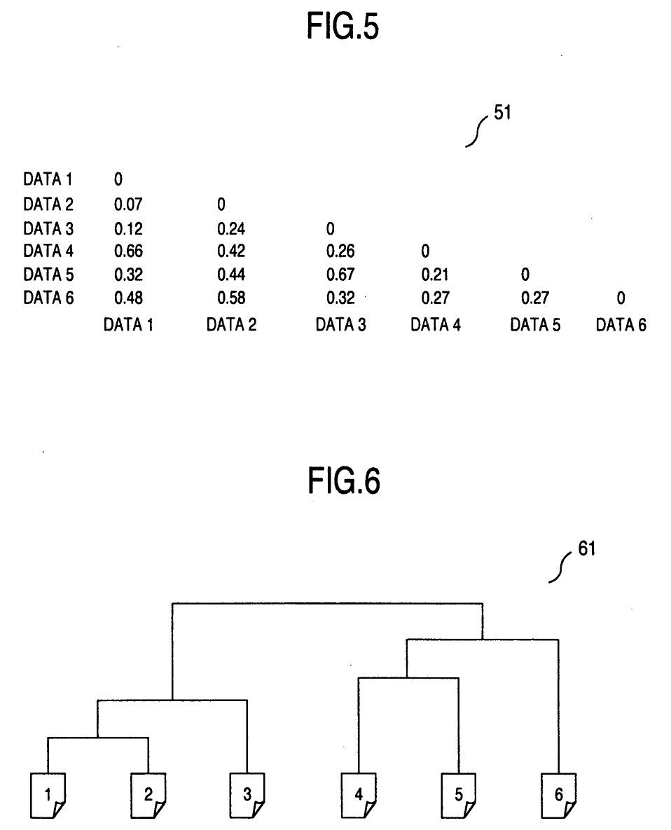

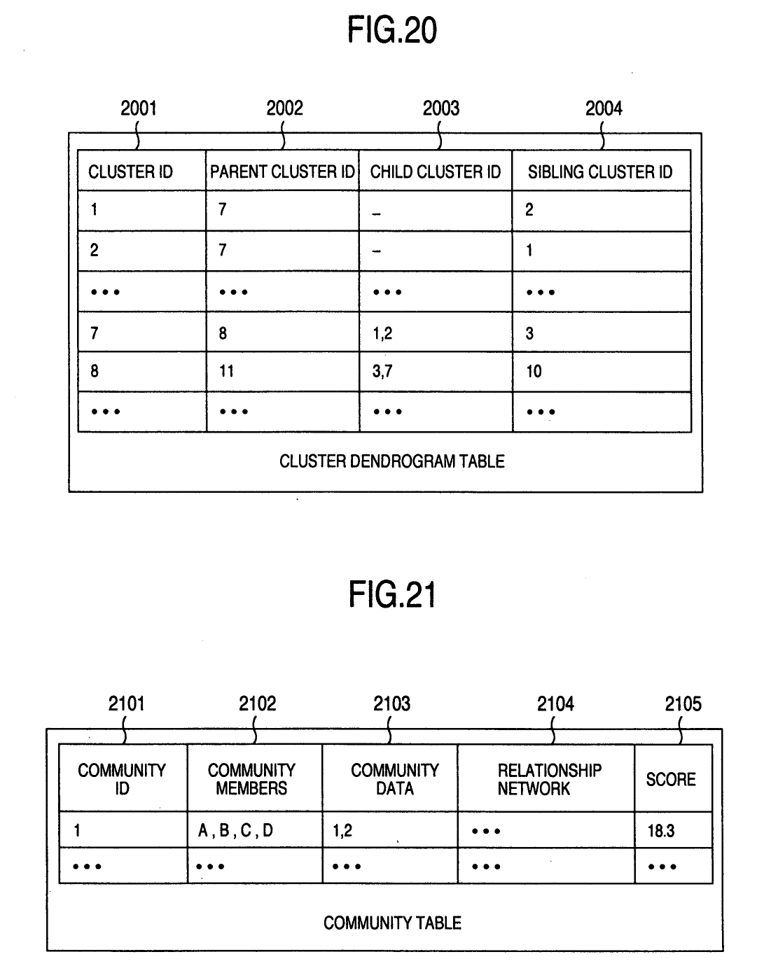

At a relationship data clustering step S22, the distance matrix calculated at S21 is input, and the cluster dendrogram of relationship data is output. The clustering dendrogram calculating method may be a hierarchical clustering approach (“Pattern Classification” by Richard O. Duda et al., Second Edition, Chapter 10, pp. 550 to 557, A Wile y-Interscience Publication, 2001) or the like. Clusters of relationship data having a variety of sizes can be formed by using the cluster dendrogram. As a cluster is added with a cluster having the shortest distance, it is possible to expand the cluster in accordance with data similarity. The cluster dendrogram calculated from the input distance matrix shown in FIG. 5 is shown in FIG. 6. Data with labels of “1” to “6” in FIG. 6 correspond to data 1 to data 6 which are row and column elements of the distance matrix shown in FIG. 5. The cluster dendrogram in FIG. 6 is managed by a cluster dendrogram table shown in FIG. 20. The table has a cluster ID 2001, a parent cluster ID 2002, a child cluster ID 2003 and a sibling cluster ID 2004. In the example of the dendrogram of FIG. 6, a cluster (cluster 1) having the cluster ID of “1” constituted of data 1 has as the parent cluster a cluster 7 constituted of data 1 and 2 and as the sibling cluster a cluster 2 constituted of data 2, and does not have a child cluster. The cluster 7 has as the parent cluster a cluster 8 constituted of data 1, 2 and 3, as the child cluster the cluster 1 constituted of data 1 and the cluster 2 constituted of data 2, and as the sibling cluster a cluster 3 constituted of data 3.

FIG. 3 is the flow chart illustrating the step S13 of mapping a communication core to a dendrogram subtree.

Input at a communication core mapping step S31 are the cluster dendrogram output at S11 and a set of communication cores output at S12. Members of each dendrogram subtree are used as a set of persons having relationships represented by the relationship data contained in the subtree, and correspondences between each communication core and a dendrogram subtree having a highest member duplication is output. A member duplication may be defined as a formula 3. With this step, each communication core is related to a dendrogram subtree, which pair of core and subtree becomes a starting point for forming a community.

$$Member duplication = \frac{{n}_{m 1 ⋂ 2}}{( {n}_{m 1} + {n}_{m 2} ) / 2} \qquad ( 3 )$$

where nₘ₁ is the number of members of set 1, nₘ₂ is the number of members of set 2, and n_{m1∩2} is the number of duplicated members of set 1 and 2.

Input at a core aggregation step S32 is a correspondence between the communication core and dendrogram output at S31. If a plurality of communication cores are mapped to the same subtree or the subtrees having an inclusion relationship, the communication cores are aggregated in accordance with a condition, and a set of pairs of the communication core and subtree is output. The condition for aggregation may use the member duplication (formula 3). Namely, if the member duplication between communication cores is not smaller than a threshold value, the communication cores are aggregated, and a sum of members of both the communication cores is regarded as one communication core. If there are three or more communication cores, aggregation is performed starting from the pair having the highest duplication. With this step, redundant communication cores extracted at S12 are aggregated and reduced.

FIG. 4 is the flow chart illustrating the detailed process at the community forming step S14. A set of pairs of the communication core and subtree output at S13 is input at S14, a community is formed for each pair by the process illustrated in the flow chart of FIG. 4, and a set of formed communities is output. An input of the process illustrated in the flow chart of FIG. 4 is a pair of the communication core and subtree, and an output is a community formed from the input pair.

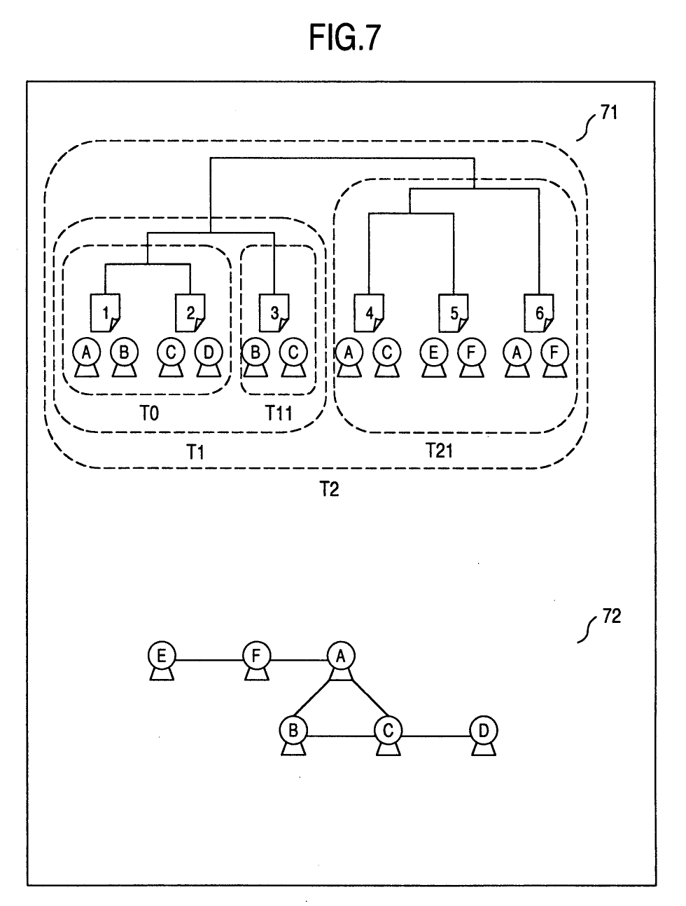

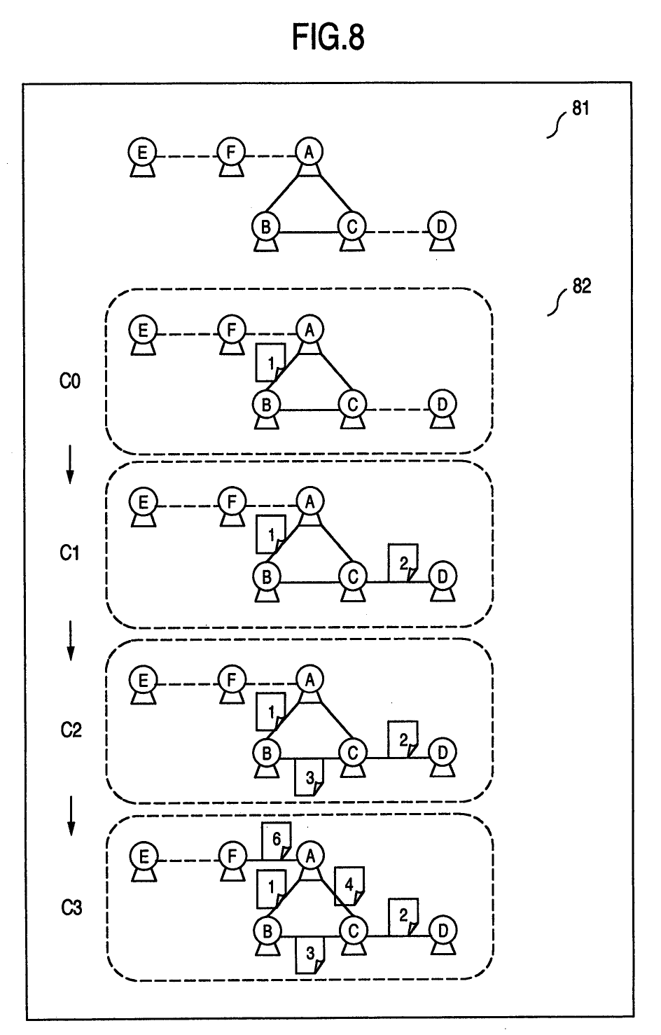

Each step of the flow chart of FIG. 4 will be described with reference to FIGS. 7 and 8. A cluster dendrogram 71 shown in FIG. 7 is the same as the dendrogram shown in FIG. 6. Under data 1 to data 6, two persons (any two of A to F) having the relationship represented by the data are shown. The network 72 of FIG. 7 is the human relationship network represented by the cluster dendrogram 71. A to F at 72 correspond to the persons A to F at 71.

The human relationship network 72 is input at S12, and a communication core constituted of three persons A, B and C is output if 1-Clique is used. It can be said intuitively that the communication core indicates a set of persons having dense relationships. This is indicated at 81 in FIG. 8. This communication core is input at S13 so that the communication core is mapped to a dendrogram subtree T₀ at 71. Next, the communication core constituted of three persons (A, B, C) and dendrogram subtree T₀ is input at S41.

At the current cluster initial value setting step S41, the input dendrogram subtree is set as the initial value of a current cluster. The current cluster represents a dendrogram subtree under processing. T₀ at 71 is the initial value of the current cluster.

At a community initial value setting step S42, an initial value is set to a community. The community is constituted of community members and community data. The community members are a set of members constituting the community, and the community data is a set of data transferred in the community. The initial value of the community members is a set of members duplicated in the input communication core and current cluster. The initial value of the community data is a set of relationship data transferred between arbitrary two persons in the initial community members, among the relationship data belonging to the current cluster. In the example shown in FIG. 7, the community members are (A, B, C) and the community data is data 1. This is shown in C₀ at 82 in FIG. 8.

At a community member/data adding step S43, member/data is newly added to the community. A member to be added is a person included in the current cluster, not included in the community, and satisfying a condition. The addition condition may be defined as a person having direct relationship with the community members via the relationship data contained in the current cluster. The data to be added is the data included in the current cluster, not included in the community and transferred between community members (including a newly added person). With this step, a person suitable for a community member is added by considering two criteria: relationship data and a relationship with the community. In the example shown in FIG. 7, the person D having relationship with the community member C via data 2 is added to the community member, and data2 is added to the community data. This is shown in C₁ at 82 in FIG. 8.

At a termination judging step S44, termination of the community forming process is judged. A termination condition can be defined by the following three threshold values and their combination. The first threshold value is a relationship density indicated by a formula 4. If the relationship density becomes not larger than the threshold value, the community forming process is terminated. The second threshold value is the number of process repetitions. The number of process repetitions indicates that a cluster at a hierarchical level higher than by what levels, starting from the cluster input at S41, is used as the process object. As the number of process repetitions becomes large, a similarity degree of relationship data in the current cluster becomes low. The third threshold value is a size of a cluster to be added to the next process. If the size of the cluster to be added to the next process is not smaller than the threshold value, the community forming process is terminated. It can be considered that if the size of the cluster to be processed is large, this cluster contains many data having a low similarity to the data in the clusters already processed. With this step, a border of a set recognized as a community is determined. The threshold values are assumed that a community density is 60%, the number of process repetitions is “5” or until the root of the cluster dendrogram reaches, and an added cluster size is “10” data pieces. In C₁ at 82, the community density is 4/6=0.67, the number of process repetitions is “1”, and the added cluster size is “1” (cluster T₁₁ at 71). None of these values exceeds the threshold values.

$$Relationship density = \frac{{n}_{d}}{{n}_{m} ( {n}_{m} - 1 ) / 2} \qquad ( 4 )$$

where nₘ is the number of community members, and n_{d} is the number of community data pieces.

At a current cluster updating step S45, a parent cluster of the current cluster is used as the new current cluster. This step is executed when the termination judgement at S44 is “NO”, and after the execution of this step, the flow returns to S43. With this step, the hierarchical level is raised by one level to form a larger cluster as the range of a community formation. In the example shown in FIG. 7, since the termination judgement at S44 was “NO”, the flow advances to S45 whereat T₁ is used as the current cluster.

After the completion of the process at S45, the flow returns to S43 whereat members and data are added. In the example shown in FIG. 7, there is no added community member, and data 3 is added to the community data. This is shown in C₂ at 82.

After the completion of the process at S43, the flow advances to S44 whereat the process termination judgement is performed. In C₂ at 82, the community density is 4/6=0.67, the number of process repetitions is “2”, and the added cluster size is “3” (cluster T₂₁ at 71). None of these values exceeds the threshold values.

Since the termination judgement at S44 is “No”, the flow advances to S45 whereat T₂ becomes a new current cluster. Returning to S43, F having relationship with A is added to the community member, and data 4 and data 6 are added to the community data. Because F is not the community member of community C₂ (82 of FIG. 8), E having relationship with F via data 5 is not added to the community member. This is shown in C₃ at 82.

After the completion of the process at S43, the flow advances to S44 whereat the process termination judgement is performed. In C₃ at 82, the community density is 5/10=0.5, the number of process repetitions is “3”, and the added cluster size is “0”. Since the community density exceeds (is not larger than) the threshold value, the termination condition is satisfied.

A community output step S46 is executed if the termination judgement at S44 is “Yes”, and outputs the formed community. However, the output community is a community immediately before the community density exceeds the threshold value. In the example of FIG. 7, C₂ at 82 is output.

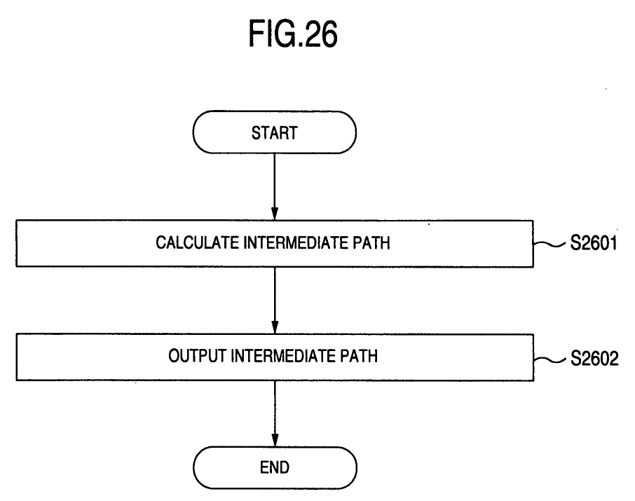

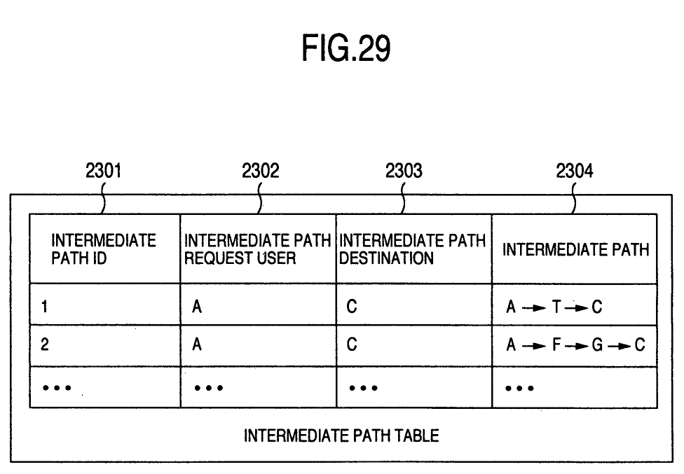

Next, with reference to FIG. 26, description will be made on the intermediate path search unit 1211. At an intermediate path calculating step S2601, an intermediate path interconnecting a user transmitted the intermediate path search query and a destination expert user is calculated by using the intermediate path search query and relationship network matrix. The process at S2601 is executed by the intermediate path calculation unit 1205. The intermediate path calculating method may be the Warshall-Floyd method (“Graphs, Networks and Algorithms” by Dieter Jungnickel, (3. Shortest Paths), Springer, published on Oct. 31, 2004) which calculates shortest paths between two nodes on a network. The calculated shortest paths are managed by an intermediate path table such as shown in FIG. 29.

At an intermediate path output step S2602, the intermediate path calculated at S2601 is output. The user transmitted the intermediate path search query can ask the person on the output intermediate path to contact the destination expert.

The function of the Know-Who search server has been described above.

Next, with reference to FIG. 11, the function of the information terminal 905 will be described. The information terminal 905 has an application 910 for communication and an application 909 for Know-Who search. The Know-Who search application controls the operation regarding the Know-Who functions, and communicates with the Know-Who search server via a Know-Who search information transmission/reception unit 1113 of an information transmission/reception module 1111. Know-Who search request transmission, screen display of a Know-Who search result and the like are executed by a Know-Who search control unit 1107 of a Know-Who search control module 1105. The communication application controls the operation regarding the functions of inter-terminal communication, and communicates with the SIP server and presence server via a communication transmission/reception unit 1109. A text/audio/video I/O unit 1102 of a communication control module 1101 manages information from external I/O devices, and controls communication with the SIP server. A presence bodylist control unit controls communication with the presence server, and controls the display of a presence bodylist. The Know-Who search application and communication application cooperate by using a communication control unit 1106 and a communication control information transmission/reception unit 1112 of the Know-Who search application, an application operation control unit 1104 and an application control information transmission/reception unit 1110 of the communication application.

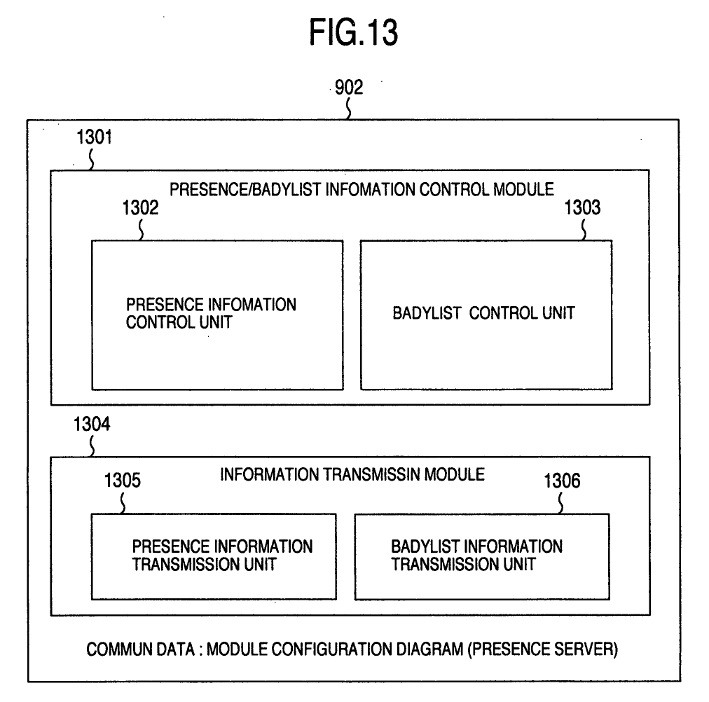

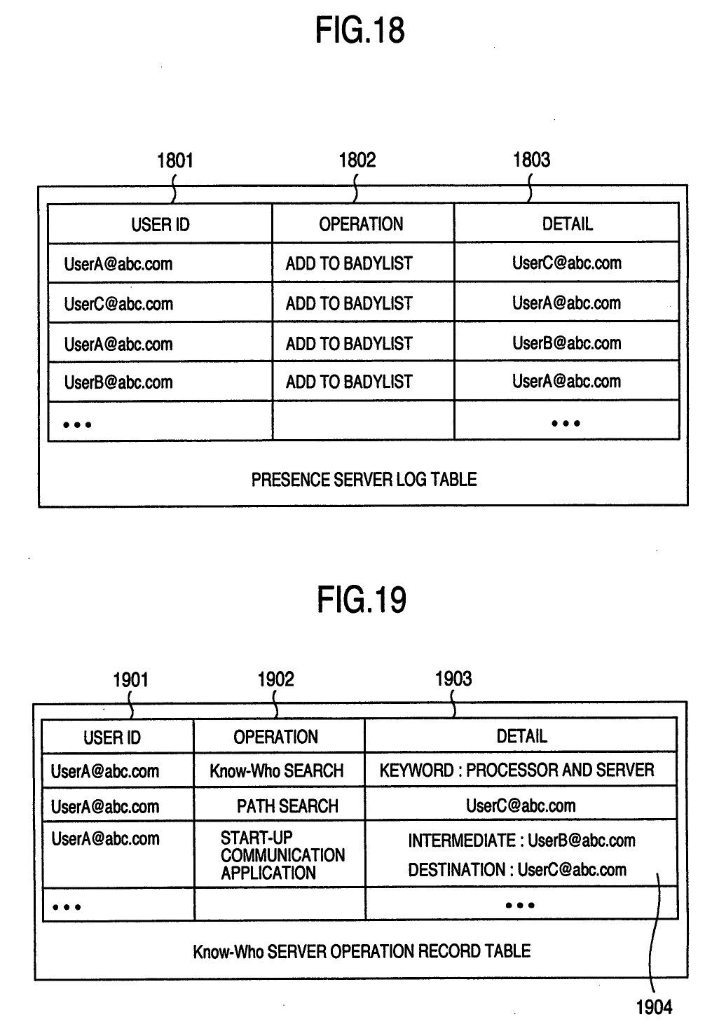

Next, with reference to FIG. 13, the functions of the presence server will be described. The presence server 902 receives presence information of the information terminal at a presence information transmission/reception unit 1305 of an information transmission/reception module 1304, and manages the received information at a presence information control unit 1302 of a presence/bodylist information control module 1301. A bodylist information transmission unit 1306 receives information on a bodylist add/delete operation by the information terminal, and manages the received information at a bodylist control unit 1303. The presence/bodylist information is managed in the format such as a presence server log table shown in FIG. 18. This table has a user ID 1801, a user operation 1802 and the details 1803 of the user operation.

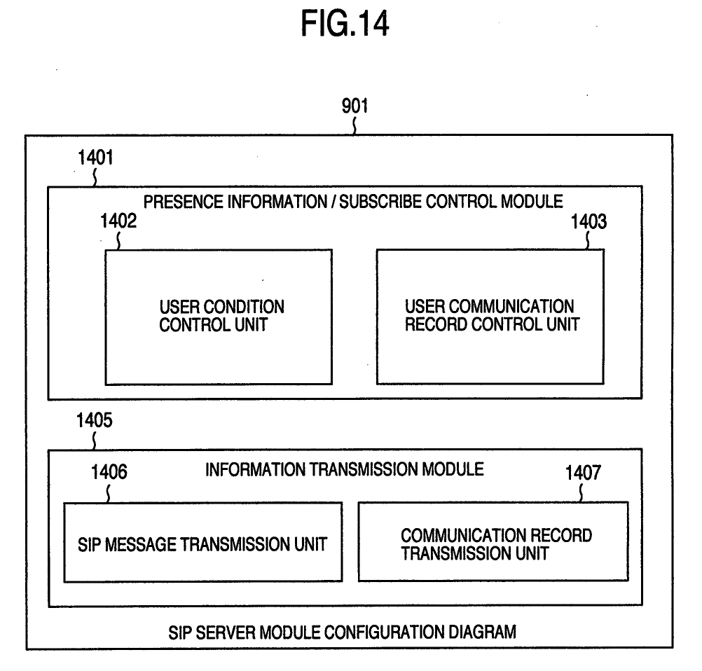

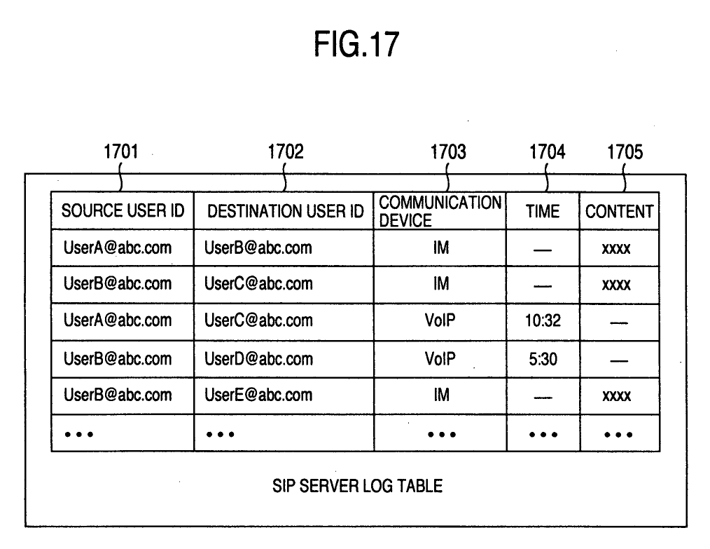

Next, with reference to FIG. 14, the functions of the SIP server will be described. The SIP server 901 relays communications between information terminals transmitting/receiving messages by using a user condition control unit 1402 of a presence information/subscribe control module 1401 and a SIP message transmission/reception unit 1406 of an information transmission/reception module 1405. A user communication record control unit 1403 manages a communication record between information terminals, and a communication record transmission/reception unit 1407 notifies a communication record between information terminals to the Know-Who search server. The communication record between information terminals is managed in the format such as a SIP server log table shown in FIG. 17. This table has a source user ID 1701, a destination user ID 1702, a communication device 1703, a communication time 1704 and a communication content (such as text) 1705.

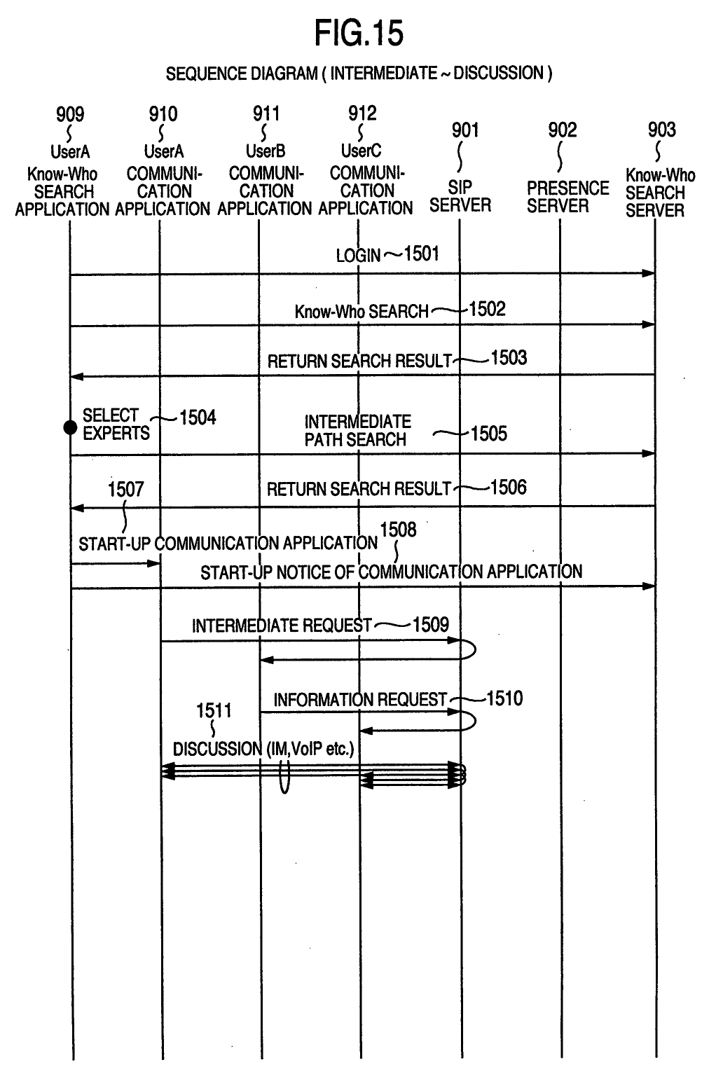

FIG. 15 is a diagram illustrating an operation sequence of the system shown in FIG. 9. With reference to the operation sequence shown in FIG. 15, the details of the operation of the system shown in FIG. 9 will be described.

FIG. 15 is a sequence diagram illustrating the communication operation between a user A and an expert user C using Know-Who search.

At Step 1501 the user A logs in the Know-Who search server. At Step 1502 the user A transmits a Know-Who search request to the Know-Who search server 903. A particular knowledge field as a search query is given by a keyword or the like. The Know-Who search server received the search request executes a Know-Who search process, and transmits at Step 1503 a search result. At Step 1504 the user A selects an expert desired to be communicated, by using the search result displayed by the Know-Who search application of the information terminal. At Step 1505 the user A transmits a search request for an intermediate path between the user A and selected expert, to the Know-Who search server 903. Upon reception of the intermediate path search request, the Know-Who search server executes an intermediate path search process, and transmits at Step 1506 the search result. The user A selects a user B as an intermediate person from the search result displayed by the search application 909 of the information terminal, and starts up at Step 1507 the communication application. At Step 1508 the Know-Who search application of the information terminal of the user A transmits a communication application start-up notice to the Know-Who search server. At Step 1509 the user A transmits an intermediate request relative to the user B, to the SIP server. The SIP server transmits an intermediate request to the communication application of the user B. The user B received the intermediate request transmits an information request relative to the user C to the SIP server. The SIP server transmits an information request to the communication application of the user C. At Step 1511 the user C received the information request makes a discussion with the user A.

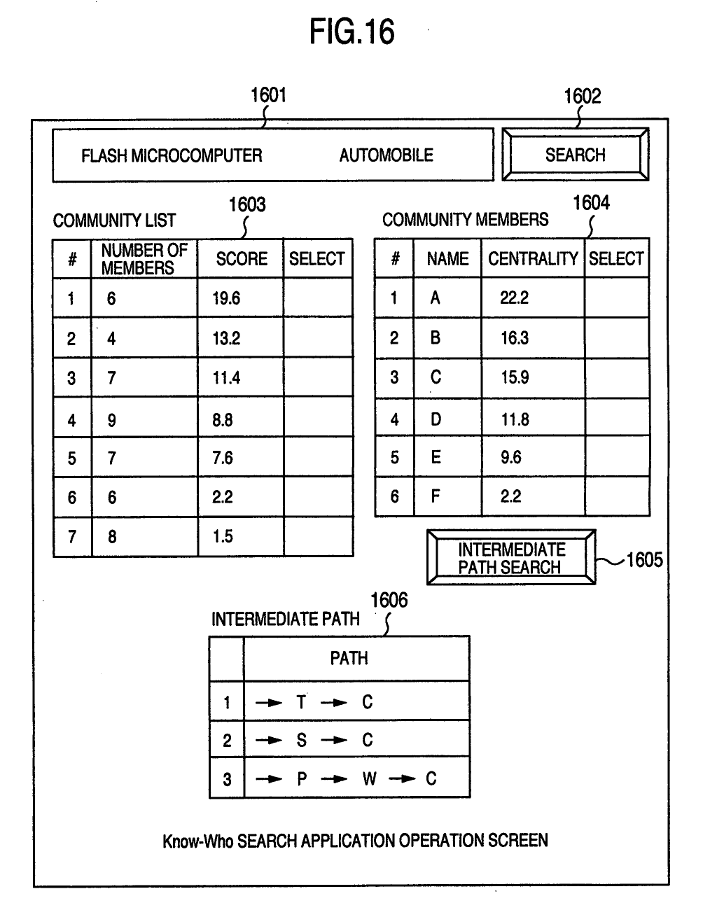

FIG. 16 is a diagram showing a Know-Who search application operation screen of a Know-Who search result displayed at the information terminal. Reference numeral 1601 represents a query input field, and reference numeral 1602 represents a Know-Who search button. As this button is clicked, a Know-Who search request is transmitted from the information terminal to the Know-Who search server. Reference numeral 1603 represents a community list. Displayed in this list are communities output at Step 2504 and received from the Know-Who search server. The community list is displayed by sorting the communities in the order of score calculated at S2502. Reference numeral 1604 represents a community member list which displays members of the community selected in the select field of the community list 1603 and centralities calculated at S2604. The community member list is displayed by sorting the members in the order of centrality. Reference numeral 1605 represents an intermediate path search button. As this button is clicked, an intermediate path search request relative to the person selected in the select field of the list 1604 is transmitted from the search execution user of the information terminal to the Know-Who search server. Reference numeral 1606 represents an intermediate path list which displays the intermediate path search result output at S2602 and received from the Know-Who search server.

By using the interface shown in FIG. 16, the user can search a community pertaining to an interesting theme (in this example, “Flash microcomputer” and “automobile”), can view the community list 1603, and can view the members of the selected community in the member list 1604. If the user desires to participate in the community, the user can contact a community member by using a path in the intermediate path list 1606, or can participate in the community.

As an example of participation, in accordance with a search record of a user or a communication record of an intermediate path, the user performed this search or communication may be automatically added to a community. Namely, user actions may be fed back when a human relationship network is configured.

### Second Embodiment

In the second embodiment, description will be made on a Know-Who search system utilizing a communication extracting method. With the communication extracting method, the Know-Who search server receives from the SIP server a Know-Who search operation record of a user and a communication record of the user followed by the user operation, and communications of the user with intermediate persons and experts presented on intermediate paths are fed back to a human relation configuring unit of the Know-Who search server, as a new configuration of human relationship and a change in already existing human relationship, to thereby reflect spontaneity of communications using Know-Who search.

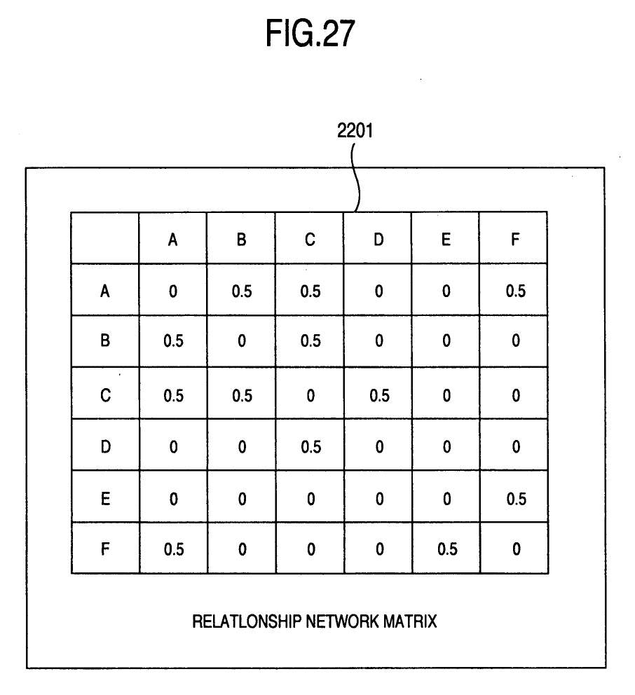

In the second embodiment, the element of the relationship network matrix shown in FIG. 22 is represented not by a presence/absence (0, 1) of relationship, but by a value from 0 to 1 reflecting a weight of relationship. FIG. 27 shows an example of the relationship network matrix of the second embodiment. For example, a presence/absence of standard relationship is defined as a weight of “0.5”, and if the relationship network matrix is updated by the above-described spontaneous relationship configuration, a value of an element between the user and expert is increased in the range not larger than “1”. This means to reinforce the relationship. Depending upon a condition, the element may be decreased in the range not smaller than “0” to reflect the weakened relationship. This means to reflect degraded relationship between the user and expert.

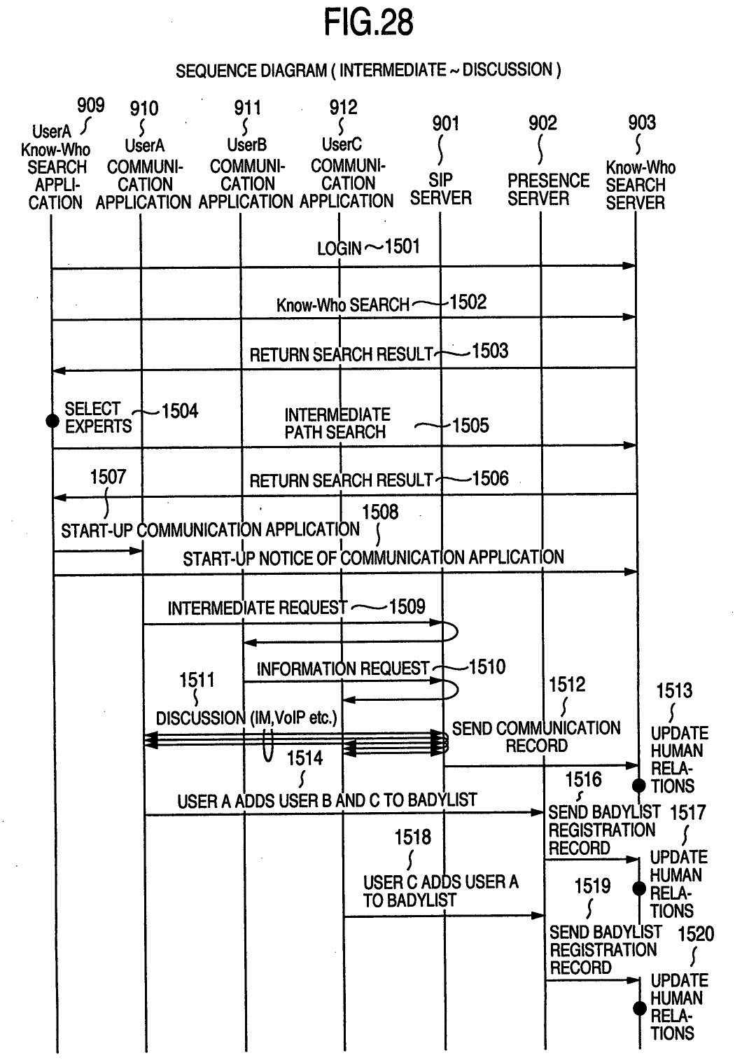

With reference to FIG. 28, description will now be made on a process of feeding back a change in human relationships according to the second embodiment.

In FIG. 28, the sequence from Step 1501 to Step 1511 is similar to the sequence described with reference to FIG. 15. At Step 1512 the SIP server transmits a communication record between users A and C to the Know-Who search server. More specifically, the content of each record of the table shown in FIG. 17 possessed by the SIP server is transmitted. At Step 1513 the Know-Who search server executes a human relationship updating process by using the communication record.

With these operations, if effective communication is performed using the Know-Who search system, it is judged that the user A intends to configure a new relationship network relative to the expert user C, and a corresponding element of the relationship network matrix between the user A and expert user C is set. More specifically, a communication record shown in FIG. 17 and received by the Know-Who search server at Step 1512 is compared with information such as a record 1904 shown in FIG. 19 and indicating a start of communication in an operation record of each user held in the Know-Who search server, to thereby judge an occurrence of communications using the Know-Who search server. In this case, a value is set which is larger than the weight “0.5” representative of the presence/absence of standard relationship, because a spontaneous relationship is considered a stronger relationship. More specifically, a present element value (it is assumed herein that an initial value is 0.5) is increased by a predetermined increment formula. For example, a new element value may be (x+(1−x)*B) where x is a present element value, and B is a positive number not larger than “1”. This means to reinforce the relationship. In this case, the relationship network matrix may be increased symmetrically, i.e., both the relationship of the user with the expert and the relationship of the expert with the user may be increased, or only the relationship of the user with the expert may be increased.

The intermediate user B as an intermediate person between the user A and expert user C increases the element value of the relationship network matrix, because the intermediate user can be evaluated as the actually functioning relationship which contributes to forming the new spontaneous relationship between other persons. In this case, the relationship network matrix may be increased symmetrically, i.e., both the relationship of the intermediate source user with the intermediate destination user and the relationship of the intermediate destination user with the intermediate source user may be increased, or only the relationship of the intermediate source user with the intermediate destination user may be increased. In the latter case, the relationship is unidirectional.

At Step 1514, the user A transmits a registration request to the presence server 902, the registration request requesting to register the effective intermediate user B and the expert user C desired to continue discussion also in the future, into the bodylist. At Step 1516 the presence server 902 transmits a bodylist registration record to the Know-Who search server 903. More specifically, transmitted is a content of each record of a table shown in FIG. 18 that held in the presence server. Similar to the above-described communication, the Know-Who search server compares the record shown in FIG. 18 with the record 1904 shown in FIG. 19, to thereby judge an occurrence of a bodylist registration using the Know-Who search server. At Step 1517 the Know-Who search server executes the human relationship updating process.

Registration to the bodylist contributes to configuring stronger human relationship than the relationship of several mail exchanges. As described above, at Step 1517 the Know-Who search server 903 increases the corresponding element value of the relationship network matrix.

Since the bodylist can be set and reset as desired by intention of one of the relevant users, when the bodylist is set to the relationship network matrix, it is set as an unidirectional relationship. Needless to say, deletion from the bodylist corresponds to decreasing the corresponding element value.

Further, at Step 1518 the expert user C transmits a registration request to the presence server, the registration request requesting to register the user A desired to continue discussion also in the future, into the bodylist. At Step 1519 the presence server transmits a bodylist registration record to the Know-Who search server. At Step 1520 the Know-Who search server executes the human relationship updating process. Processes at Steps 1518, 1519 and 1520 are similar to the processes at Steps 1514, 1516 and 1517.

Generally, whether the expert user C as the main person of the community registers the user A in the bodylist influences whether the user A can be added as a member of the community. This system emulates this situation.

As described above, as the record of communication using the Know-Who search system is fed back, an informal and stronger communication core can be extracted and a community having a strong relationship can be extracted.

More specifically, a more informal and stronger relationship community can be extracted by using the relationship network matrix of FIG. 27 using continuous values representative of relationships when communication cores are extracted, or by changing at the community member/data adding step S43 the condition definition of a person having a direct relationship with the community member to the condition definition of a person having a relationship with the community member of strength (i.e., a element value of the relationship network matrix) not smaller than a predetermined value (e.g., 0.6).

As above, in this embodiment, by using the human relationship network and clustering of relationship data, it becomes possible to extract a community of a set of persons having common relationship data and high mutual relationship density.

By forming communities by considering each content of relationships, it is possible to extract a community in which a person having a plurality of roles can be participated at the same time in communities having respective roles.

By extracting community data representative of a content of relationships forming each community, it becomes possible to express accurately the features of topics and interests of the community and to search the community coincident with a keyword.

Further, by feeding back the communication record, it becomes possible to extract a community more faithful to actual human relationships.

The present invention is applicable to an advertisement distribution/information providing system in the Internet, an organization analysis system for supporting organization consulting, a Know-Who search system, a community search system and the like.

It should be further understood by those skilled in the art that although the foregoing description has been made on embodiments of the invention, the invention is not limited thereto and various changes and modifications may be made without departing from the spirit of the invention and the scope of the appended claims.

1. A community extracting method to be executed by an information processing apparatus including at least data storing means for storing data and data processing means for processing the data stored in said data storing means, the community extracting method comprising steps of:
forming a human relationship network indicating relationships of users and storing said human relationship network in said data storing means;
forming a dendrogram formed by clustering relationship data of said users in accordance with a similarity degree and storing said dendrogram in said data storing means;
extracting one or more communication cores each including at least a portion of said users as constituent members, from said human relationship network;
mapping said communication core to said dendrogram to extract a community including at least the portion of said constituent members.

2. The community extracting method according to claim 1, wherein said step of mapping said communication core to said dendrogram uses a multiplicity between said constituent members of said communication core and said constituent members of a cluster of said dendrogram.

3. The community extracting method according to claim 2, wherein said step of extracting said community sequentially repeats processes of:
searching another cluster having a higher similarity degree by using said dendrogram;
using a user relevant to the relationship data belonging to said searched cluster, as an addition candidate to said community; and
if said addition candidate user and any member of said community have a human relationship based on the relationship data belonging to said searched cluster, adding said addition candidate user as a member of said community.

4. The community extracting method according to claim 3, wherein said step of extracting said community is terminated in accordance with a threshold value of a relationship density in said community.

5. The community extracting method according to claim 3, wherein said step of extracting said community is terminated in accordance with a threshold value of a size of a cluster of said dendrogram to be added next to said community.

6. The community extracting method according to claim 3, wherein said step of extracting said community is terminated in accordance with a threshold value of the number of repetitions of a process of searching a cluster of said dendrogram and adding a member to said community.

7. The community extracting method according to claim 4, further comprising a step of, if a plurality of communities are obtained based on said one or more communication cores, aggregating said plurality of communities.

8. The community extracting method according to claim 7, wherein said step of aggregating said communities determines whether said communities are aggregated to one community, in accordance with threshold values of a multiplicity of two communities and a similarity degree, between the two communities, of relationship data relevant to members added during a process of forming each community.

9. A community extracting apparatus including at least data storing means for storing data and data processing means for processing the data stored in said data storing means, wherein said data processing means comprises:
human relationship network configuring means for forming a human relationship network expressing relationships of users as a network structure;
dendrogram forming means for forming a dendrogram formed by clustering relationship data representative of relationship of said users constituting said human relationship network, in accordance with a similarity degree;
extracting one or more communication cores forming a high density portion in accordance with a graph theory, from said human relationship network; and
community forming means for mapping said communication core to said dendrogram.

10. A community extracting apparatus according to claim 9, wherein said community forming means is equipped with community forming process terminating means.

11. A community extracting apparatus according to claim 9, further comprising community aggregating means.

12. A community extracting apparatus according to claim 9, wherein said human relationship network configuring means feed back a search record or a communication record of each user for configuring said human relationship network.

13. The community extracting method according to claim 5, further comprising a step of, if a plurality of communities are obtained based on said one or more communication cores, aggregating said plurality of communities.

14. The community extracting method according to claim 6, further comprising a step of, if a plurality of communities are obtained based on said one or more communication cores, aggregating said plurality of communities.
